(19) United States
(12) Patent Application Publication
(10) Pub. No.: US 2002/0190412 A1
(43) Pub. Date: Dec. 19, 2002

(54) In-die control method for manufacturing super thin housings for semiconductor memory cards

(76) Inventor: Chin-Chen Huang, Taipei (TW)

Correspondence Address: David E. Dougherty, Dennison, Schultz & Dougherty, 612 Crystal Square 4, 1745 Jefferson Davis Highway, Arlington, VA, 22202, US

(21) Appl. No.: 09/882,040

(22) Filed: Jun. 18, 2001

(51) Int. Cl. B29C 45/77

(52) U.S. Cl. 264/40.5; 264/328.1

(57) ABSTRACT

An in-die control method for manufacturing super thin housings for semiconductor memory cards, it uses a closable die set, a vacuum pump, a pressure detecting device and a digital control device, wherein: A vacuum pump is connected with the article shaping area of the die set; the pressure detecting device is connected to the internal camber of the die set and is operated in the mode of in-die control, so that during injecting under a high pressure to press feeding material, a vacuum pump in the shaping area of the die set is activated, and simultaneously gas in the die set is extracted outwardly to prevent creating of back pressure; meantime, the pressure detecting device detects the internal pressure of the die set, when the pressure detected is overly large, the digital control device is activated to manipulate the injection molding apparatus to return the feeding material in time. Thereby, the pressure in the die set is always kept at the preset value, and super thin housings with thickness of about only 0.12 mm can be manufactured.

### BACKGROUND OF THE INVENTION

1. Field of the Invention

The present invention is related to an injection molding and shaping method of super thin housings in manufacturing controlled super thin products such as semiconductor memory cards, light guide plates, batteries etc., and especially to such a method which, in addition to using a push rod and an oil pressure apparatus on the press closing die portions to exert pressure onto the male and female die portions for injection molding, uses a vacuum pump, a pressure detecting device and a digital control device etc. to manufacture super thin housings with thickness of about only 0.12 mm, thereby, volumes of semiconductor memory cards can be further contracted to increase the industrial value of such products.

2. Description of the Prior Art

Conventional manufacturing processes for injection molding plastic dies have plastic granules molten with high temperature into fluids, then the dies are closed and are injected under a high pressure to press the plastic fluid into the dies, after molding and shaping, the plastic is chilled and shaped. Some places a movable punch head in the hollow chamber of a die when a first die portion and a second die portion are closed and contacted with each other for injection molding.

Conventional injection molding under high pressure suits manufacturing those housings of larger thickness (more than about 1.5 mm), this can be appropriate for the technique of injection molding and shaping of normal daily necessities. However, this has the defect of inapplicability for the new industry of production of semiconductor memory cards. The reason is that normal daily necessities do not have a severe requirement on the thickness of their housings, while the semiconductor memory cards such as MS cards and SD cards do require small volumes, light weight and super thinness; the conventional technique of injection molding can not get a thickness of 0.12 mm after shaping, housings of such thickness are subjected to breakage under a high pressure or subjected to cracking and damage by residual stress. In fact, housings of the thickness of only 0.30 mm are unable to be obtained by the conventional technique of injection molding.

In view that the thickness of housings of articles made by the conventional technique of injection molding so largely influences the quality of semiconductor memory cards, and the conventional technique of injection molding is resided therein the above stated defects, the inventor developed the present invention against the defects and made improvement thereupon.

### SUMMARY OF THE INVENTION

Therefore, the main object of the present invention is to provide an in-die control method for manufacturing super thin housings for semiconductor memory cards, it can effectively produce housings of the thickness of less than 0.30 mm suiting semiconductor memory cards.

The secondary object of the present invention is to provide an in-die control method for manufacturing super thin housings for semiconductor memory cards, it can prevent the super thin housings from having the problem of residual stress, thus the super thin housings are not subjected to breakage or cracking and damage.

Another object of the present invention is to provide an in-die control method for manufacturing super thin housings for semiconductor memory cards, it can accurately control the small sizes of the super thin housings.

To get the above stated objects, the equipment of the present invention includes at least:

a closable die set;

a vacuum pump;

a pressure detecting device; and

a digital control device.

Wherein, the vacuum pump is connected with an article shaping area of the die set, the pressure detecting device is connected to the internal camber of the die set and is operated in the mode of in-die control, so that during injecting under a high pressure to press feeding material, a vacuum pump in the shaping area of the die set is activated, and simultaneously gas in the die set is extracted outwardly to prevent creating of back pressure and to increase uniform distribution of the injected feeding material; meantime, the pressure detecting device detects the internal pressure of the die set, when the pressure detected is overly large, the digital control device is activated to manipulate the injection molding apparatus to return the feeding material in time. Thereby, the pressure in the die set is always kept at the preset value, and super thin housings with thickness of about only 0.12 mm can be manufactured.

The present invention will be apparent in its specific structure, principle applied, functions and effects after reading the detailed description of the preferred example thereof in reference to the accompanying drawings.

### BRIEF DESCRIPTION OF THE DRAWINGS

FIG. 1 is a schematic top view of a semiconductor memory card related to the present invention;

FIG. 2 shows a flow chart of the present invention;

FIG. 3 is a schematic sectional view showing the injection molding apparatus of the present invention;

FIG. 4 is an analysis diagram showing speed vs. stroke of an injection molding process under a super high speed in the first example of the present invention.

### DETAILED DESCRIPTION OF THE PREFERRED EXAMPLE

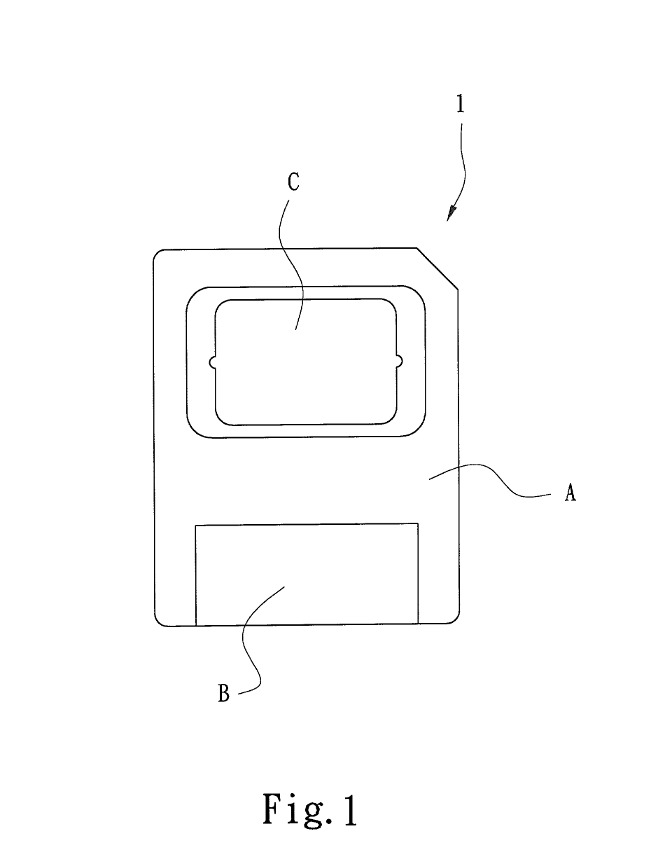

Referring to the drawings, FIG. 1 shows a top view of a semiconductor memory card (MS card) related to the present invention. Wherein, the card 1 is divided into a plurality of plate areas of different thickness, the standard specification for the larger area “A” is about 0.8 mm thick, the recessed area “B” for sticking on a mark is about 0.6 mm thick, the area “C” for embedding therein a chip near the middle upper portion needs to be of the thickness of only about 0.14 mm. When two halves of the card 1 are closed to envelop the chip, a semiconductor memory card providing digital stored data is completed.

However, the abovementioned area “C” for embedding therein a chip is of the thickness of only about 0.14 mm, a conventional technique of injection process generally is unable to process such a housing as this article. Thereby, the point of the present invention is to provide effective processing capability for such a super thin article.

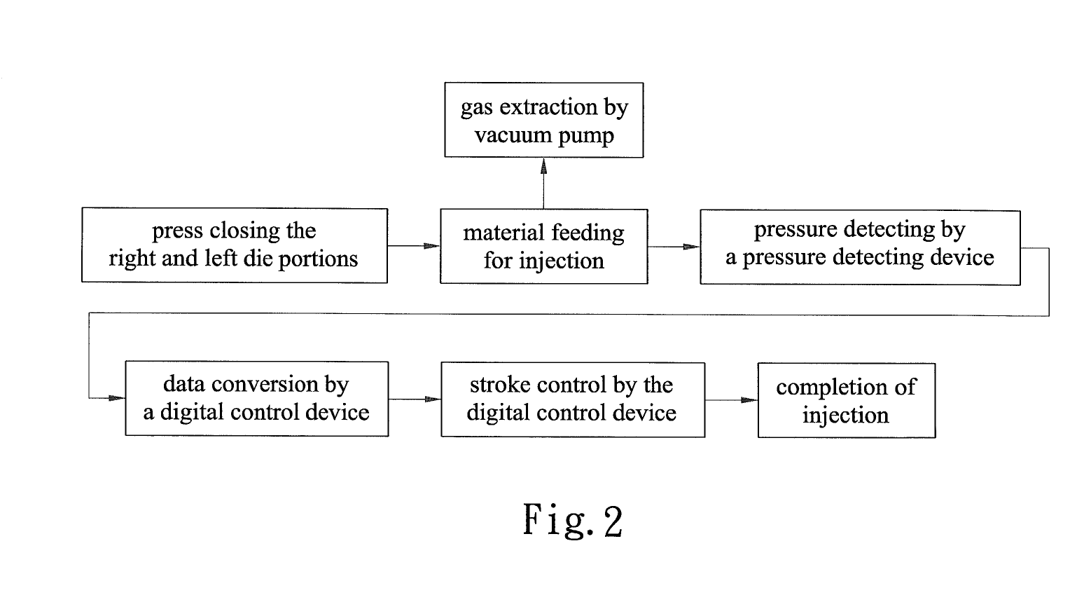

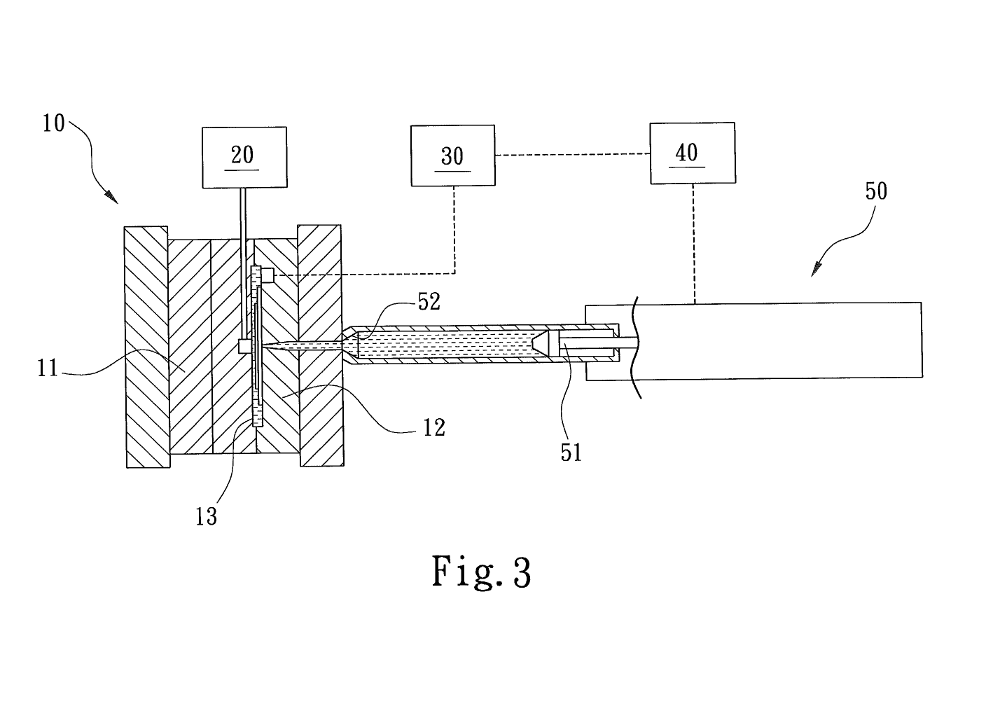

Referring to FIGS. 2 and 3, the basic equipment used in the present invention includes a closable die set 10, a vacuum pump 20, a pressure detecting device 30 and a digital control device 40.

The die set 10 includes a right die portion 11 and a left die portion 12 which are automatically pressed to close to each other, the right and the left die portions 11, 12 form a chamber 13 therebetween. The vacuum pump 20 is connected to a specific position in the chamber 13 in an article shaping area of the die set 10; a vacuum pumping area provided therein preferably is exactly the shaping area of the thin housing, so that the injected plastic material extends from the thicker areas to the thinner areas. And the pressure detecting device 30 is connected with and placed in the chamber 13 in the die set 10 in the mode of in-die control. A material press pushing device 50 of a high speed injection molding apparatus is provided and has a pusher rod 51 therein; a front contracted feed inlet 52 of the material press pushing device 50 is connected with the die set 10. The pressure detecting device 30 is communicated with the digital control device 40 which can be controlled by means of a preset program to render the pusher rod 51 of the material press pushing device 50 to retract to provide a material returning function.

Thereby, when the injection molding apparatus activates the material press pushing device 50 to have molten resin pushed into the die set 10 by the pusher rod 51 through the front contracted feed inlet 52, it gets an impulse force with a super high pressure to simultaneously activate the vacuum pump 20 which can thus prevent generating back pressure under high speed injecting impulsion by cooperation with the synchronic extraction of gas out of the chamber 13 during feeding material. Thereby, an advantage of no creating of residual stress on the housing can be obtained; this correspondingly increases uniform distribution of the injected feeding material.

The pressure detecting device 30 is provided to detect the internal pressure of the die set 10, when the pressure detected is overly large, the digital control device 40 is activated to manipulate the injection molding apparatus to activate the pusher rod 51 of the material press pushing device 50 to retract fast to return the feeding material in time. Thereby, the pressure in the die set 10 is always kept at the preset value which has been precisely calculated. The gap between the right and the left die portions 11, 12 of the chamber 13 can be designed without difficulty to only has a width of 0.12 mm. However, it is uneasy to keep the uniformity of the super thin housing without leaving residual stress which renders fragile under a high pressure impulsion. The present invention has the pressure value in the chamber 13 of the die set 10 controlled to be under the preset value, hence is able to effect injection molding of such super thin housing.

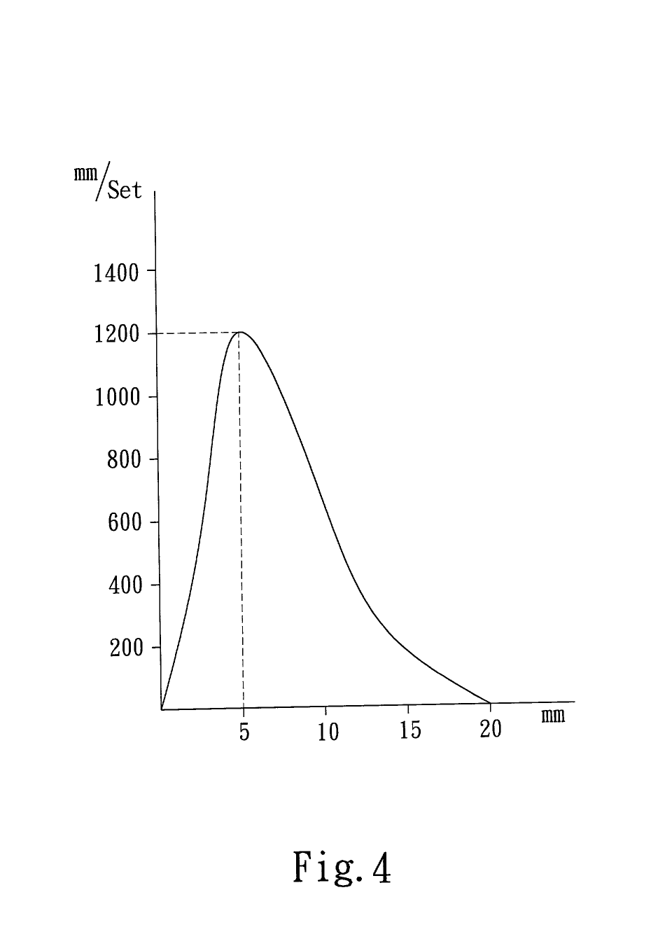

The so called super high pressure injection process in this field of processing, under a high pressure of 1200 mm/sec. can only obtain a pusher rod of a material press pushing device practically with an effective stoke of only 5 mm long (as shown in FIG. 4), the high pressure induced will be accumulated in the die set. In view of this, precise pressure control in the die set is extremely important.

Accordingly, some conventional related industrial techniques have the pressure detecting device installed at the material press pushing device outside of the die set to control the amount of injected material for shaping. The super thin article produced by the present invention is tested in the die set for pressure to control further feeding or returning material after obtaining the amount of injected material. In this way, the specific areas can get super thin thickness, and this is economic and practical; and the defects resided in the conventional techniques can be gotten rid of. Having thus described the injection molding method of super thin housings of the present invention which has not yet been published.

What is claimed is

1. An in-die control method for manufacturing super thin housings for semiconductor memory cards, said method uses a closable die set, a vacuum pump, a pressure detecting device and a digital control device, and is characterized by the following steps:
a. said vacuum pump is connected with an article shaping area of said die set;
b. said pressure detecting device is connected to an internal camber of said die set and is operated in the mode of in-die control to detect the pressure value in said article shaping area of said die set;
c. said digital control device is connected to a material press pushing device of a high speed resin injection molding apparatus;
d. a material press feeding process is practiced by a high speed injection molding technique under cooperation with synchronic extraction of gas out of said chamber by means of said vacuum pump;
e. said pressure detecting device tests the pressure value of press feeding material in said die set to be discriminated by said digital control device, the result of discrimination is used further to control reverse retracting of said material press pushing device of said high speed injection molding apparatus or to further feeding; the specific pressure in said die set is kept at a preset value.

2. An in-die control method for manufacturing super thin housings for semiconductor memory cards as in claim 1, wherein:
the area where said vacuum pump is connected with said article shaping area of said die set is the shaping area of said thin housing.
